(19) United States
(12) Patent Application Publication
(10) Pub. No.: US 2012/0130291 A1
(43) Pub. Date: May 24, 2012

(54) EZ-Chest Percussion Therapy

(76) Inventors: Laurie A. Dillingham, San Antonio, TX (US); Jeffrey P. Dillingham, San Antonio, TX (US)

(21) Appl. No.: 12/952,728

(22) Filed: Nov. 23, 2010

(51) Int. Cl. A61H 23/00

(52) U.S. Cl. 601/107

(57) ABSTRACT

A hand held, manually operated apparatus for use in applying bursts of air under pressure to the chest wall of a human during chest percussion therapy having a cup shaped outer shell terminating at a lower substantially circular continuous edge and a cup shaped inner shell terminating at a lower substantially circular continuous edge where the outer and the inner shells are joined together at their substantially circular continuous edges to form a substantially flat surface and a sealed chamber between the outer and inner shells. A fluid is located within the sealed chamber between the outer and inner shells, and the inner shell forms an open concave chamber that extends into the inner shell from the substantially circular continuous edge of the inner shell. An elongated handle is removably attached to the closed end of the outer shell.

### BACKGROUND OF THE INVENTION

1. Field of the Invention

The present invention relates to and is useful for respiratory therapy. More particularly, the present invention involves an apparatus which is repeatedly struck against or applied to the chest wall of a person for the purpose of delivering percussion to the lung area. The percussion effects aid in loosening trapped secretions in a person's lungs. The technique is particularly useful where trapped and/or excessive lung secretions are a problem.

2. Description of Related Art

Pneumatic and mechanical systems for loosening and helping to remove secretions from a person's lungs is known in the prior art. More specifically, by way of example, U.S. PreGrant Publication No. 2008/0086065 to Holm; et al. discloses a portable, handheld device for manual percussive respiratory therapy in infants and young children having a pear-shaped dome for positioning the device over a person, a handle, a cushioned sealing mechanism for softening the impact on a patient, and indicator means to indicate proper positioning and engagement of the device during use.

U.S. Pat. No. 6,984,214 to Fowler-Hawkins discloses a reed located in a housing, and an acoustical resistance. The reed produces a low-frequency audio shockwave in a range of about 12 Hz to about 30 Hz when vibrated. The acoustical resistance couples a patient lung cavity to the audio shockwave, thereby vibrating the patient's lung cavity.

U.S. Pat. No. 6,053,879 to Leban, et al. discloses a control console having a sound generator for generating sounds, and a patient contact board. The control console has knobs for adjusting the frequency, wavelength, duration and volume of the sounds from the sound generator, and a power cord for connecting the control console to a power source. The contact board has a plurality of speakers mounted on the front face of the board and connected to the sound generator for transmitting the sounds generated by said sound generator

U.S. Pat. No. 4,745,910 to Day, et al. discloses a lightweight flexible cantilever handle and a soft elastomeric percussion cup secured to the distal end of the handle. The bell-shape of the percussion cup provides a percussion shock wave and sound, while accommodating a wide range of striking forces and angles relative to any desired body surface.

U.S. Pat. No. 4,429,688 to Duffy discloses a partially enclosed cavity which presents a circular opening bordered by an annular ring of moldably compressible material for providing a pneumatic seal of the cavity to a person. The annular ring defines a groove which communicates with a curling semi-circular lip, the ring also defines a cavity filled with a vapor for cushioning the impact of the appliance with a patient's body.

U.S. Pat. No. 4,196,722 to Vanderwoude discloses a main body member formed of resilient material and includes a sidewall portion and an end cap portion which are integrally connected and sealed together to define a continuous concave interior chamber. A base edge of the sidewall portion circumscribes an opening into the interior chamber. A sealing cuff of resilient and compressible material is attached to the base edge. A flattened interior end wall surface extends generally in parallel and planar spaced apart relation from a plane defined by the sealing cuff and base edge.

U.S. Pat. No. 3,955,563 to Maione discloses pneumatic power to provide a given reciprocating motion which can be regulated either by electronic pulse, or fluidic air, control.

U.S. Pat. No. 7,736,324 to Helgeson discloses an air pressure and air pulse generator located within a case mount on a pedestal having wheels to facilitate movement of the apparatus.

U.S. Pat. No. 5,569,170 to Hansen discloses a diaphragm located within a housing connected to a wave generator and amplifier to vibrate the diaphragm. The vibrating diaphragm produces air pressure pulses which are delivered to a person.

### SUMMARY OF THE INVENTION

In an exemplary embodiment of the present invention, there is disclosed a hand held, manually operated apparatus for use in applying bursts of air under pressure to the chest wall of a human during chest percussion therapy having a cup shaped outer shell terminating at a lower substantially circular continuous edge and a cup shaped inner shell terminating at a lower substantially circular continuous edge where the outer and inner shells are joined together at their substantially circular continuous edges to form a substantially flat surface and a sealed chamber between the outer and inner shells. A fluid such as a liquid or air is located within the sealed chamber between the outer and inner shells, and the inner shell forms an open concave chamber that extends into the inner shell from the substantially circular continuous edge of the inner shell. An elongated handle is removably attached to the closed end of the outer shell.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a hand held device for performing Chest Percussion Therapy on a person in accordance with the principles of the invention;

FIG. 2 is a side view of the hand held device of FIG. 1 for performing Chest Percussion Therapy on a person in accordance with the principles of the invention;

FIG. 3 is an exploded side view of an interchangeable head being attached to the handle of the hand held device for performing Chest Percussion Therapy on a person in accordance with the principles of the invention; and

FIGS. 4A, 4B, 4C and 4D are front views of four different size interchangeable heads which can be attached to the handle.

### DESCRIPTION OF THE PREFERRED EMBODIMENT

Chest Percussion Therapy (CPT) is a procedure which is used to help patients breathe more freely and to get more oxygen into their body by loosening lung secretions and allowing them to come out of the body as a part of the respiratory therapy. The therapy can be used with children and adults. Chest Percussion Therapy is preformed by successive and uniformly pressing a yieldable cup against a child's or adult's chest for short periods of time. The repeatedly applied pressure helps to break up and allow secretions in the child's or adult's lungs to be removed. It is understood that the successive and uniformly striking a yieldable cup against the child's or adult's chest for short periods of time causes the lungs to vibrate which loosens the secretions

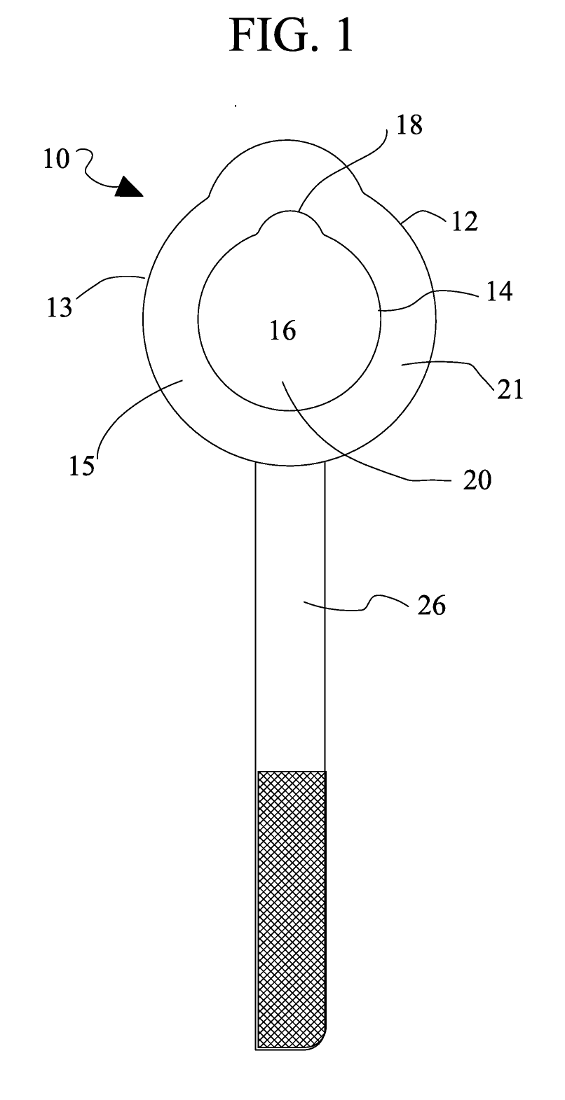

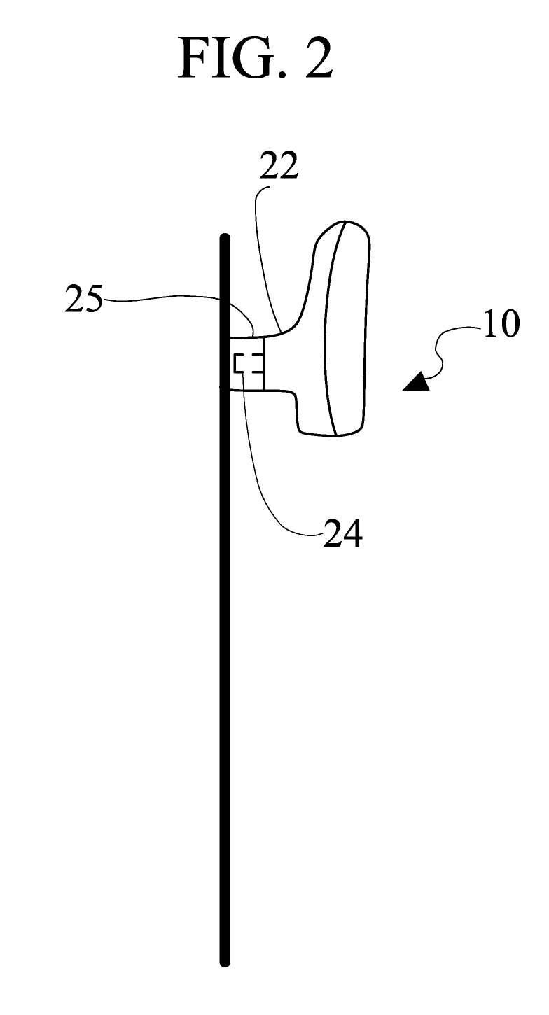

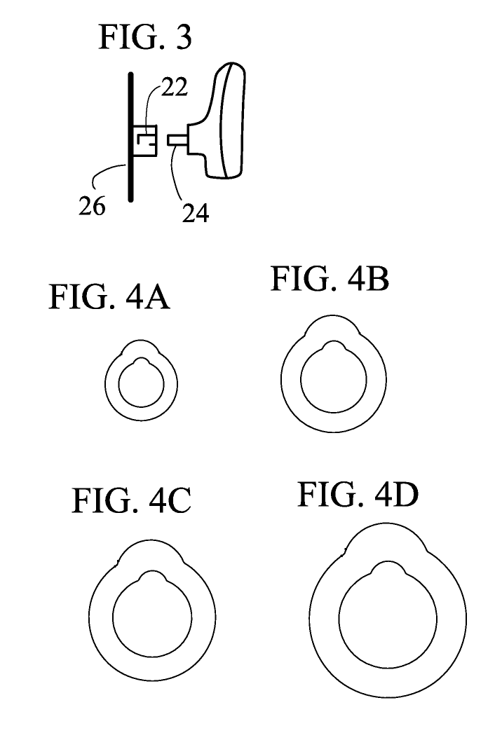

Referring to FIGS. 1, 2 and 3 there is disclosed a front, side and exploded view of a hand held device for performing Chest Percussion Therapy on a person in accordance with the principles of the invention. The hand held device 10 includes an outer shell 12 composed of a soft yieldable air and water impermeable plastic which has a cup shape. Integrally connected to the outer shell at the bottom end of the outer shell 12 is an inner shell 14 composed of a yieldable air and water impermeable plastic which also has a cup shape and may be of a plastic that is more yieldable than the outer shell.

The outer shell 12 and the inner shell 14 form a cup shaped unitary body member 13 which has a sealed chamber 15 located between the outer and inner shells, where the inner shell forms a concave interior chamber 16. The lower edge of the each shell is substantially circular except for a small semicircular deviation 18 at the top of the outer and inner shells.

The bottom edge of the hand held device defines an opening 20 to the concave interior chamber 16. Different size devices are used on individuals of different sizes and, therefore, the diameter of the opening 20 is determined by the size of the individual. At the bottom edge of the hand held device 10, the inner shell is displaced from the outer shell to form a continuous, smooth bottom surface 21 that has a width of about one-half of an inch, more or less which contacts the chest of a user.

Attached to the top of the outer shell of the cup shaped device 10 is a cylindrical member 22 of solid plastic which includes a connecting pin 24. Connecting pin 24 may be composed of plastic or metal such as iron, brass, copper, or the like and may have either a screw thread or wedge shaped teeth on its circumference. The cylinder can have a length of about one-half of an inch and the connecting pin can have a length of about three eighths of an inch. The height of the outer shell from the smooth bottom surface 21 to the bottom of the cylindrical member is about three-eighths of an inch more or less.

The chamber between the outer and inner shells may be filled with a fluid such as a liquid or a gas. When filled with a liquid, the substance may be water, alcohol, glycerin or the like. When filled with a gas, the substance may be air which is at a pressure of between four inches and twenty inches of pressure above atmospheric pressure. A preferred pressure is about eight inches of pressure, more or less, above atmospheric pressure. If desired, a valve may be located in the wall of the outer shell for providing either air or a gas to the chamber between the outer and inner shells.

The connecting pin 24 connected to the cylindrical member 22 on the cup shaped unitary body member 13 is adapted to be received by an opening located in a cylinder 25 of plastic which is attached to a handle 26 which has a length of about seven inches, a width of about five-eighths of an inch and a thickness of about one millimeter. The handle is composed of a rigid or semi rigid plastic and the lower half of the handle has a rubber coating grip. The opening in the plastic cylinder 25 has an internal thread which is adapted to receive the threaded connecting pin, or wedge shaped teeth which are adapted to be in locking engage with the wedge shaped teeth on the connecting pin.

In use, the lower portion of the handle of the cup shaped unitary body member is grasped by a person and oriented to have the concave interior chamber face the chest or upper back portion of a child or adult that is to be treated. The cup shaped unitary body member is also oriented to insure that the entire continuous smooth bottom surface 21 will contact the person being treated each time that the bottom surface makes contact with the child or adult being treated. As the continuous smooth bottom surface makes contact with the person being treated, the bottom surface makes a seal with the skin of the person being treated and a pressure wave is created which penetrates into and vibrates the lungs.

Referring to FIGS. 4A-4D, there is shown front views of four different size interchangeable heads which can be attached to the handle for use with different size individuals. The cup shaped unitary body of FIG. 4A is sized for use with infants weighing between one pound and about fourteen pounds and has an overall diameter of about thirty three millimeters. The cup shaped unitary body of FIG. 4B is sized for use with infants having larger body sizes of between fourteen pounds and twenty pounds and has an overall diameter of about forty six millimeters. The cup shaped unitary body of FIG. 4C is sized for use with children and has an overall diameter of about sixty three millimeters. The cup shaped unitary body of FIG. 4D is sized for use with adults. The various dimensions of the cup shaped unitary body shown in FIGS. 4A, 4B and 4C are substantially similar to a cup shaped unitary body which is sized for use with adults shown in FIG. 4D. The cup shaped unitary bodies of FIGS. 4A-4C are similar in all aspects to the shape of the cup shaped unitary body of FIG. 4D except for the dimensions of the various parts. Therefore, it is understood that the various dimensions of the various parts of the cup shaped unitary bodies of FIGS. 4A-4C are reduced to maintain the same relative relationships.

The idea behind chest percussion is to loosen lung secretions to allow them to come out of the body as a part of the respiratory therapy. The fluid filled chamber in the cup shaped unitary body allows for a more comfortable type of therapy for the patient, and the cup design allows for a more aggressive/successful “thump” that helps loosen more secretions. The elongated handle allows a Respiratory Therapist to perform CPT with a flick of his/her wrist as opposed to using his/her entire arm with the traditional “cup” as fatigue plays a big role when using a traditional cup. The handle design also allows patients to perform effective CPT on themselves with only a flick of the wrist.

Prior to this invention, effective manual self CPT has been virtually unavailable with the previous CPT “cup” models. The handle creates enough kinetic energy when applied back and forth through small movements of a person's wrist that even a weak individual can take advantage of this kinetic energy created by the invention here disclose to achieve desired results. The rubber grip on the handle also allows for weaker patients i.e., arthritic patients, ill patients, etc, to easily grip the hand held device and, in return, give themselves more effective treatment.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A hand held, manually operated apparatus for use in applying bursts of air pressure to the chest wall of a human during chest percussion therapy comprising:
a unitary body having a cup shaped outer shell terminating at a lower substantially circular continuous edge and a cup shaped inner shell terminating at a lower substantially circular continuous edge;
the outer shell and the inner shell are joined together at their substantially circular continuous edges to form a substantially flat surface and a sealed chamber between the outer and inner shells;
a fluid located within the sealed chamber between the outer and inner shells;
an open concave chamber that extends into the inner shell from the substantially circular continuous edge of the inner shell; and
an elongated handle with one end attached to the outer shell.

2. The hand held apparatus of claim 1 wherein the fluid located within the sealed chamber between the outer and inner shells is a gas.

3. The hand held apparatus of claim 2 wherein the gas is air.

4. The hand held apparatus of claim 3 wherein the air is at a pressure that is above atmospheric pressure.

5. The hand held apparatus of claim 4 wherein the pressure is between four inches and 20 inches of pressure above atmospheric pressure.

6. The hand held apparatus of claim 5 wherein the pressure is about four inches of pressure above atmospheric pressure.

7. The hand held apparatus of claim 1 wherein the fluid located within the sealed chamber between the outer and inner shells is water, alcohol or glycerin.

8. The hand held apparatus of claim 1 wherein the outer and inner shells are made of a soft yieldable plastic.

9. The hand held apparatus of claim 8 wherein the inner shell is made of a yieldable plastic that is more yieldable than the yieldable plastic of the outer shell.

10. The hand held apparatus of claim 8 wherein the outer and inner shells are made air and water impermeable plastic.

11. The hand held apparatus of claim 10 wherein the handle is made of plastic.

12. The hand held apparatus of claim 11 wherein the handle is removably attached to the outer shell.

13. The hand held apparatus of claim 11 wherein the plastic handle has a thickness of about one millimeter.

14. The hand held apparatus of claim 12 wherein the handle is removably attached to the outer shell with a connecting pin that is received by an opening in a plastic cylinder attached to the handle.

15. The hand held apparatus of claim 13 wherein the connecting pin and the opening in the plastic cylinder have screw threads or wedge shaped teeth which engage each other.

16. The hand held apparatus of claim 1 wherein a valve is located in the outer shell to feed fluid to the sealed chamber between the outer and inner shells.
